(19) United States
(12) Patent Application Publication
(10) Pub. No.: US 2005/0253351 A1
(43) Pub. Date: Nov. 17, 2005

(54) Preloaded suspension bracket assembly for axle housing

(76) Inventors: Jaw-Ping Pan, Lake Orion, MI (US); Mark Smith, Troy, MI (US); Harry W. Trost, Rochester Hills, MI (US); Thomas D. Buley, Berkley, MI (US); Dale J. Eschenburg, Rochester Hills, MI (US); Paul G. Bragan, Clarkston, MI (US); Rajesh J. Sommay, Troy, MI (US); Tiong T. Lie, Naperville, IL (US); Jack R. McKenzie, Clarkston, MI (US); Everett Hall, Farmington Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/845,966

(22) Filed: May 14, 2004

(51) Int. Cl. B60G 9/02

(52) U.S. Cl. 280/124.116

(57) ABSTRACT

An axle housing includes a suspension mount interface for mounting a vehicle suspension to the axle housing. The axle housing includes a first leg portion extending to a first wheel assembly and a second leg portion extending to a second wheel assembly. The first and second leg portions each include a suspension mount interface. Each suspension mount interface includes first and second bracket portions. The first and second bracket portions are clamped together prior to attachment to the axle housing to form a suspension bracket assembly. One clamped suspension bracket assembly is then slid over each axle housing leg portion. The first and second bracket portions are subjected to a preload force as they are welded or fastened to each other, providing a preload effect to define a suspension load path that has positive contact only at desired locations on the axle housing.

### BACKGROUND OF THE INVENTION

The subject invention generally relates to a suspension bracket assembly for a vehicle axle housing that is preloaded during attachment to control transfer of the load path from an input to the suspension.

Medium and heavy duty vehicles include suspensions that are attached to axle housings in various different manners. Traditionally, these suspensions include loose piece brackets that are welded to the axle housing, or are clamped to the axle housing to define a suspension mount interface. A conventional loose piece suspension mount interface includes an upper bracket positioned between an upper surface of the axle housing and a suspension main support member and a lower bracket positioned underneath the axle housing. A pair of U-bolts extends over the suspension main support member and are fastened against the lower bracket underneath the axle housing.

This suspension mount interface creates many design challenges. There are a variety of suspension types and each type of suspension can have many different configurations. This means that a variety of attachment hardware, i.e. brackets, clamps, fasteners, etc., are needed to accommodate all of the suspension mount interface variations. This proliferates components and increases cost.

Additionally, the fatigue life of the axle housing can be affected. During vehicle operation, the upper and lower brackets can rub against the axle housing. This can generate cracks in the housing, which can lead to premature wear or component failure. Also, any movement of the brackets relative to the axle housing, which may be caused by loosening of the fastener attachment, can move the suspension mount interface out of the original installation position, which can cause loading through the axle housing in undesirable locations. This can also cause premature wear or failure.

There is a need for a suspension mount interface for a vehicle axle that can accommodate many different suspension types while reducing costs by deproliferation. The suspension mount should be easily incorporated into existing axle housing configurations and should improve axle housing fatigue life in addition to overcoming the other above-mentioned deficiencies in the prior art.

### SUMMARY OF THE INVENTION

A suspension mount interface for an axle assembly utilizes a two-piece suspension bracket assembly that is pre-assembled and then installed over an axle housing. Once installed over the housing, the bracket pieces are subjected to a preload force as the pieces are attached together. The suspension bracket assembly exerts this clamping or preload force against the axle housing during the attachment process. This preload force ensures that positive contact between the suspension bracket assembly and the axle housing occurs only at predefined locations, which controls the suspension load input path regardless of the type of suspension being used or the attachment interface between the suspension and the axle housing.

In one disclosed embodiment, the suspension bracket assembly includes a first bracket member and a second bracket member. The bracket members are held fixed relative to each other and then are slid over one end of the axle housing to substantially surround the axle housing. The bracket members can be held fixed relative to each other by being clamped together in a fixture, hinged together, or fastened together prior to being installed over the axle housing. Once in position, the first and second bracket members are attached to each other. This attachment can be a welded or bolted joint. During attachment, the preload force is applied to the first and second bracket members, which exert the clamping or preload force against the housing to control the suspension load path.

The first and second bracket members are geometrically configured to ensure positive contact for the clamping force only along predetermined contact areas of the axle housing. In one disclosed embodiment, the axle housing includes a polygonal cross-section that includes a plurality of angled surfaces. The bracket members are configured such that positive contact is only exerted against the angled surfaces. Preferably, these angled surfaces are positioned at corner locations on the axle housing.

The subject suspension bracket assembly provides an improved suspension mount interface that is easily incorporated into existing axle housings and which can be used with a variety of suspensions. These and other features of the present invention can be best understood from the following specification and drawings, the following of which is a brief description.

### BRIEF DESCRIPTION OF THE DRAWINGS

FIG. 1 is a schematic view of an axle assembly with a suspension mount interface incorporating the subject invention.

FIG. 2A is a front view of one embodiment of a suspension mount interface incorporating the subject invention.

FIG. 2B is a perspective view of the embodiment shown in FIG. 2A.

FIG. 3A is a front view of another embodiment of a suspension mount interface incorporating the subject invention.

FIG. 3B is a perspective view of the embodiment shown in FIG. 3A.

FIG. 4 is a front view of another embodiment of a suspension mount interface incorporating the subject invention.

FIG. 5 is a front view of another embodiment of a suspension mount interface incorporating the subject invention.

### DETAILED DESCRIPTION OF THE PREFERRED EMBODIMENT

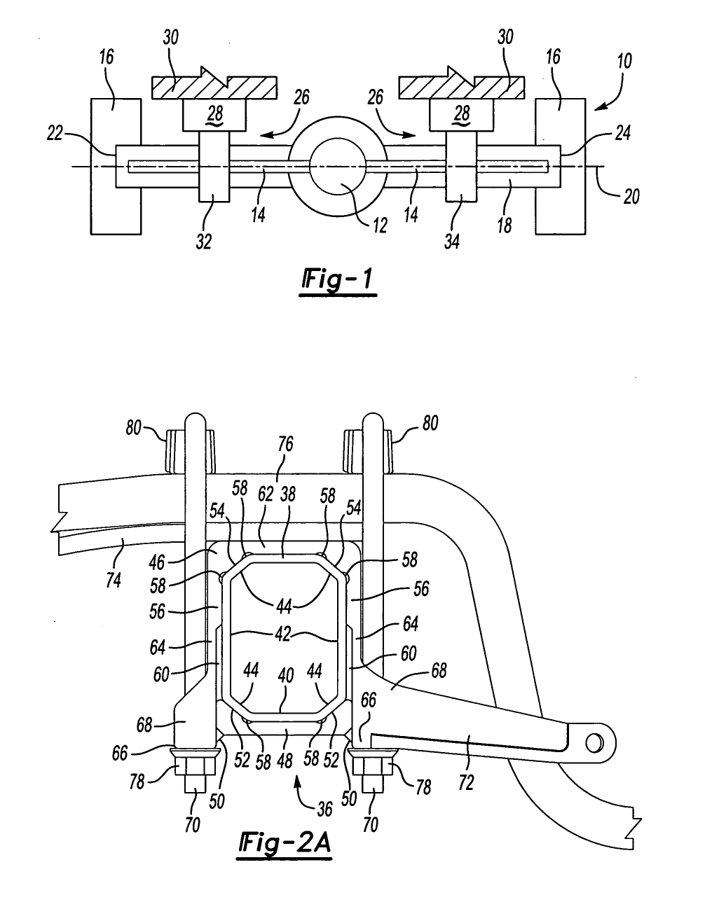

An axle assembly is shown generally at 10 in FIG. 1. The axle assembly 10 is preferably a drive axle including a center differential 12 that drives a pair of axle shafts 14. The axle shafts 14 drive wheel end assemblies 16 that support tires (not shown). The axle assembly 10 includes an axle housing 18 that substantially encloses the axle shafts 14 and the differential 12. The axle housing 18 defines a lateral axis 20 and includes a first leg portion 22 extending to one wheel end assembly 16 and a second leg portion 24 extending to the other wheel end assembly 16.

A suspension mount interface, shown generally at 26, is used to mount the axle assembly 10 to a vehicle suspension 28. The suspension 28 is supported by a vehicle frame 30. The suspension mount interface 26 includes a first bracket assembly 32 positioned at the first leg portion 22 and a second bracket assembly 34 positioned at the second leg portion 24. The bracket assemblies 32, 34 connect the axle assembly 10 to the suspension 28. While the bracket assemblies 22, 24 are shown as being used to interconnect a drive axle 10 and a suspension 28, it should be understood that the subject bracket assemblies 22, 24 could also be beneficially used in other axle configurations, such as non-drive, steer, trailer, or tag axles, for example.

The bracket assemblies 32, 34 are comprised of a two-piece configuration that is pre-assembled prior to attachment to the axle housing 18. The pre-assembled bracket pieces are held fixed relative to one another and may or may not be attached to each other. One bracket assembly is then slid over each of the first 22 and second 24 leg portions such that the bracket assemblies 32, 34 substantially surround the leg portions 22, 24. The bracket assemblies 32, 34 are then secured or attached together after being installed over the leg portions 22, 24. During the attachment process, the bracket pieces are subjected to a preload, which generates a squeezing or clamping force around the axle housing 18. This causes the bracket pieces to contact the axle housing 18 only along predetermined contact areas. This configuration helps isolate the axle housing 18 from the direct load path for suspension input loads.

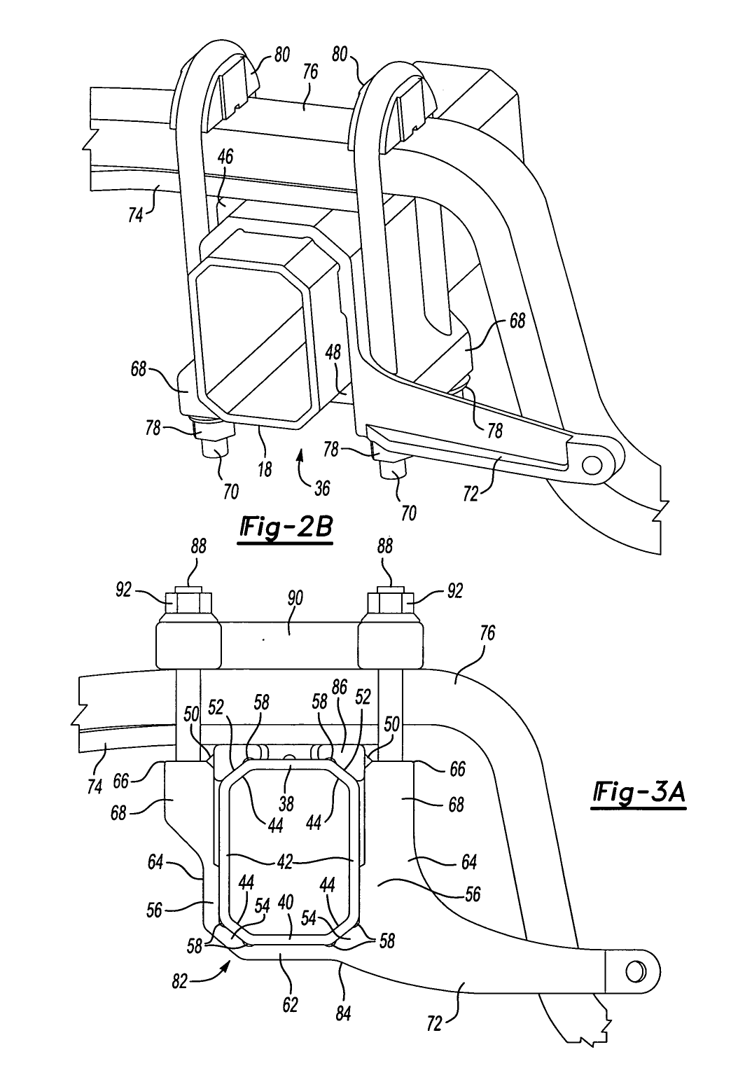

One example of a bracket assembly 36, which is installed over the first 22 and second 24 leg portions of the axle housing 18, is shown in FIGS. 2A and 2B. The axle housing 18 is preferably defined by a polygonal cross-section that can include a plurality of different configurations. In the configuration shown in FIGS. 2A and 2B, the axle housing 18 includes an upper horizontal wall 38, a lower horizontal wall 40, and a pair of vertical side walls 42. Angled surfaces 44 form corner portions between each vertical side wall 42 and the upper 38 and lower 40 horizontal surfaces. Thus, the housing 18 is of an octagonal cross-section with four (4) angled surfaces 44, i.e. four (4) corners.

The vertical side walls 42 and upper 38 and lower 40 horizontal surfaces are generally flat, and are orientated at generally ninety degrees relative to one another. In other words, the vertical side walls 42 are orientated generally perpendicular to the upper 38 and lower 40 horizontal walls. The angled surfaces 44 are non-parallel to the vertical side walls 42 and the upper 38 and lower 40 horizontal walls and thus intersect planes defined by the vertical side walls 42 and the upper 38 and lower 40 horizontal walls at an angle. While an octagonal cross-section is shown, it should be understood that the subject invention could be beneficial to other multi-sided axle housing cross-sections.

The bracket assembly 36 includes a first bracket member 46 and a second bracket member 48 that are welded together along a weld interface 50. In the configuration shown in FIGS. 2A and 2B, the first bracket member 46 is an upper bracket that extends along the upper horizontal wall 38 and both of the vertical side walls 42. The second bracket member 48 is a lower bracket that extends along the lower horizontal wall 40. The lower bracket 48 includes two (2) contact pad portions 52 that directly engage two (2) of the four (4) angled surfaces 44. The upper bracket 46 includes two (2) contact pad portions 54 that directly engage the other two (2) of the four (4) angled surfaces 44. The upper bracket 46 also includes two (2) side pad portions 56 that directly engage the vertical side walls 42 of the axle housing 18.

In this configuration, the upper 46 and lower 48 brackets are held fixed together in a fixture or other similar tooling mechanism (not shown) prior to being slid over the leg portions 22, 24 of the axle housing 18. Once the bracket assembly 36 is installed over the axle housing 18, the pre-load force is applied as the brackets 46, 48 are welded together along the weld interface 50. This preload force ensures that contact between the bracket assembly 36 and the axle housing 18 only occurs along the pad portions. The weld interface location for this configuration is preferred as the weld interface 50 between the upper 46 and lower 48 brackets is isolated from contact with the axle housing 18.

The upper 46 and lower 48 brackets include a plurality of reduced cross-sectional areas 58 that allow the brackets 46, 48 to bend during the welding process. The reduced cross-sectional areas form grooves or channels that extend in a direction parallel to the lateral axis 20. The grooves form hinge points that help the brackets 46, 48 conform to the desired orientation. In other words, the hinge points allow the brackets 46, 48 to bend ensuring that positive contact between the axle housing 18 and the brackets 46, 48 occurs only at the pad portions. This also ensures that gaps 60 are maintained between the upper bracket 46 and the vertical side walls 42.

In this configuration, the only contact between the upper 46 and lower 48 brackets occurs through a horizontal interface. There is no contact between the brackets 46, 48 where vertical loading can be transferred from the lower bracket 46 to the upper 48 bracket. This ensures that any vertical loading goes through the housing 18 at the desired angled surfaces 44.

The upper bracket 46 includes a base portion 62 and a pair of legs 64 extending downwardly from the base portion 62 to distal ends 66. The distal ends 66 each include a boss portion 68 that receives a U-bolt connection 70. One of the legs 64 includes a transversely extending arm 72 that is connected to a shock absorber (not shown). The U-bolt connection 70 is configured such that one U-bolt 70 is positioned on one vertical side of the axle housing 18 and a second U-bolt 70 is positioned on an opposite vertical side of the axle housing 18. A spring member 74 is positioned above the base portion 62 of the upper bracket 46 and below a suspension main support member 76. The U-bolts 70 extend over the main support member 76 and are fastened into the boss portions 68 with a plurality of nuts 78. Additional support members 80 can be positioned between the main support member 76 and the U-bolts 70 as needed.

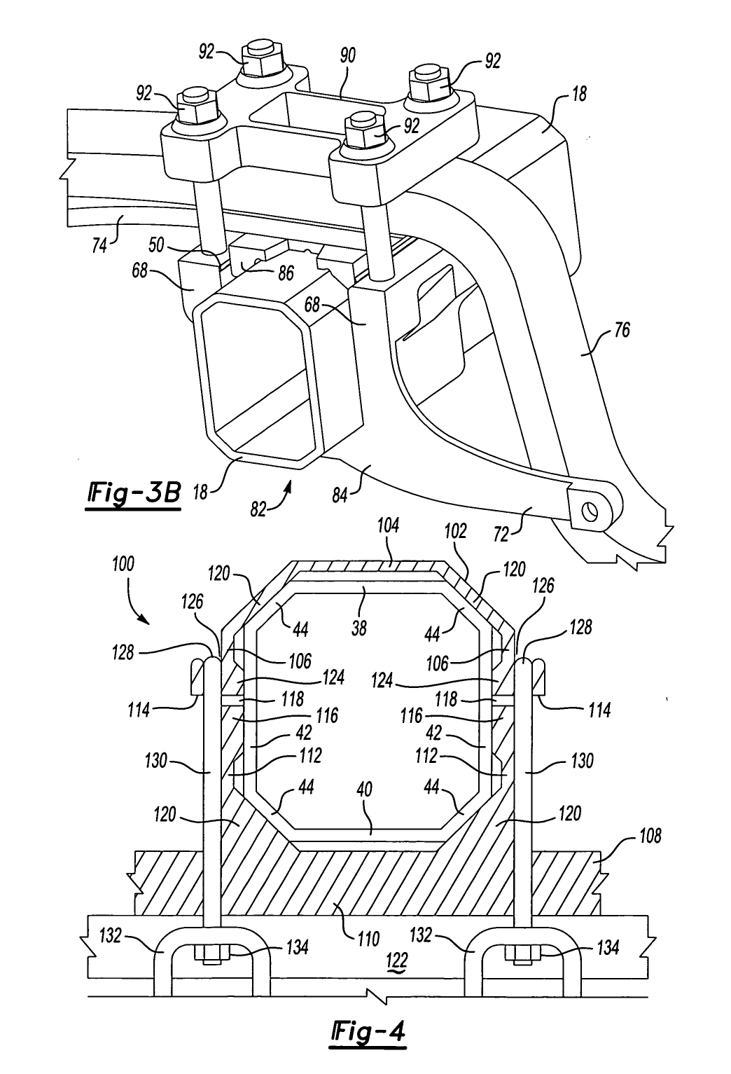

FIGS. 3A and 3B show another example of a bracket assembly 82. This configuration is similar to that of FIGS. 2A and 2B except that the first 46 and second 48 bracket positions are reversed. The upper bracket 46 of FIGS. 2A and 2B is now used as a lower bracket 84 in FIGS. 3A and 3B and the lower bracket 48 of FIGS. 2A and 2B is now used as an upper bracket 86 in FIGS. 3A and 3B. The features of the brackets 84, 86 and the attachment process for attaching the brackets 84, 86 to each other remains the same as discussed above with regard to FIGS. 2A and 2B.

One main difference with this configuration is that the U-bolt connection is eliminated. Instead, a plurality of studs 88 is used to connect the lower bracket 84 to the suspension main support member 76. An attachment member 90 is positioned on top of the main support member 76. The studs are inserted through openings in the support member 90 and extend into the bosses 68 of the leg portions 64 of the lower bracket 84. The studs 88 are fastened to the support member 90 with a plurality of nuts 92. In this configuration, the transversely extending arm 72 extends from the base portion 62 of the lower bracket 84 as opposed to extending from the distal end 66 of one of the legs 64.

FIG. 4 shows another example of a bracket assembly 100. In this configuration the bracket assembly 100 includes an upper bracket 102 having a base portion 104 and a pair of legs 106 and a lower bracket 108 having a base portion 110 and a pair of legs 112. The base portion 104 for the upper bracket 102 extends along the upper horizontal wall 38 of the axle housing 18 and the legs 106 extend along a portion of the vertical side walls 42 to distal ends 114. The base portion 110 for the lower bracket 108 extends along the lower horizontal wall 40 of the axle housing 18 and the legs 112 extend along a portion of the vertical side walls 42 to distal ends 116.

The upper 102 and lower 108 brackets are held fixed together in a fixture or other similar tooling mechanism (not shown) prior to being slid over the leg portions 22, 24 of the axle housing 18. Once the bracket assembly 100 is installed over the axle housing 18, the pre-load force is applied as the brackets 102, 108 are welded together along a weld interface 118. The weld interface 118 is formed between the distal ends 114 of the upper bracket 102 and the distal ends 116 of the lower bracket 108.

The upper 102 and lower 108 brackets each include pad portions 120, similar to those described above with regard to FIGS. 2A and 2B and 3A and 3B. The preload force applied during welding ensures that contact between the bracket assembly 100 and the axle housing 18 only occurs along the pad portions 120 and the angled surfaces 44 of the axle housing.

In this configuration, the suspension 28 is positioned underneath the axle housing 18. The suspension 28 includes a main support member 122 that is positioned below the lower bracket 108. The upper bracket 102 includes a pair of bosses 124 formed at the distal ends 114. The bosses 124 include channels 126 that receive base portions 128 for a U-bolt 130. The U-bolts 130 extend downwardly toward the main support member 122 and are fastened into an attachment member 132, supported underneath the main support member 122, with a plurality of nuts 134.

It should be understood that while the bracket assembly 100 embodiment of FIG. 4 is shown with a suspension 28 positioned underneath the axle housing 18, the bracket assembly 100 could also be used in a configuration where the suspension 28 is positioned above the axle housing 18. Further, while the bracket embodiments 36, 82 of FIGS. 2A and 2B and FIGS. 3A and 3B are shown in a configuration where the suspension 28 is positioned above the axle housing 18, the bracket assemblies 36, 82 could also be used in a configuration where the suspension 28 is positioned below the axle housing 18.

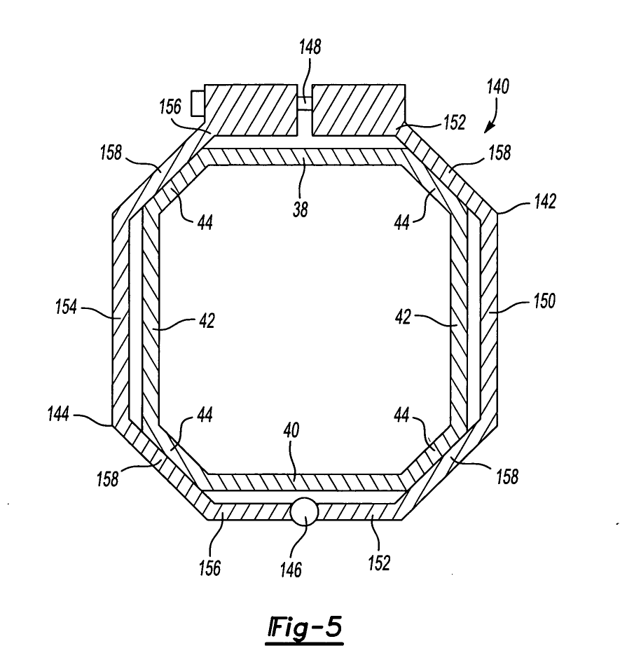

FIG. 5 shows another example of a bracket assembly 140. In this configuration, the bracket assembly 140 includes a fore bracket 142 and an aft bracket 144. The fore 142 and aft 144 brackets are hinged, bolted, or similarly connected to each other at 146, prior to installation over the leg portions 22, 24 of the axle housing 18. The fore 142 and aft 144 brackets are then assembled or wrapped around the leg portions 22, 24 from a horizontal direction. The fore 142 and aft 144 brackets are then fastened together with at least one fastener 148, which generates the preload force discussed above.

The fore bracket 142 includes a base portion 150 that extends along one vertical side wall 42 and a pair of leg portions 152 that extend along portions of the upper 38 and lower 40 horizontal walls of the axle housing 18. The aft bracket 144 includes a base portion 154 that extends along the opposite vertical side wall 44 and a pair of leg portions 156 that extend along portions of the upper 38 and lower 40 horizontal walls of the axle housing 18. One leg 152, 156 from each bracket 142, 144 is hinged or fastened together at the lower horizontal wall 40 and the other leg 152, 156 from each bracket 142, 144 is fastened together to generate the preload.

The fore 142 and aft 144 brackets each include pad portions 158, similar to those described above with regard to FIGS. 2A and 2B and FIGS. 3A and 3B. The preload force applied during fastening of the brackets 142, 144 together ensures that contact between the bracket assembly 140 and the axle housing 18 only occurs along the pad portions 158 and the angled surfaces 44 of the axle housing 18. The bracket assembly 140 is then attached to the suspension main support member 76 with U-bolts, studs, or other similar fastening methods. This configuration can be used with suspension main support members 76 that are positioned above or below the axle housing 18.

The subject invention utilizes a two-piece bracket assembly to attach a suspension to an axle assembly. A common two-piece bracket assembly can be used with many different types of vehicle suspension. Thus, the overall number of bracket components can be significantly reduced. This also simplifies integration and installation procedures for different suspension types. Further, the application of the preload during the attachment of the bracket pieces controls and directs the suspension load path to predetermined areas on the axle housing.

Although a preferred embodiment of this invention has been disclosed, a worker of ordinary skill in this art would recognize that certain modifications would come within the scope of this invention. For that reason, the following claims should be studied to determine the true scope and content of this invention.

1. A suspension bracket assembly for an axle housing comprising:
a first bracket member;
a second bracket member held fixed relative to said first bracket member;
a first attachment interface defined between said first and second bracket members to exert a preload force along predetermined contact areas on an axle housing during attachment of said first and second bracket members to the axle housing; and
a second attachment interface defined between said first and second bracket members and a suspension main support member.

2. The suspension bracket assembly of claim 1 wherein said first attachment interface comprises a welded joint.

3. The suspension bracket assembly of claim 1 wherein said second attachment interface comprises a bolted joint.

4. The suspension bracket assembly of claim 1 wherein said first attachment interface comprises a bolted joint.

5. The suspension bracket assembly of claim 4 wherein said first and second bracket members include a hinge connection interface positioned on one side of the axle housing with said bolted joint being positioned on an opposite side of the axle housing.

6-7. (canceled)

8. The suspension bracket assembly of claim 1 wherein each of said first and second bracket members include at least one reduced cross-sectional area forming a hinge to ensure positive contact only on desired surfaces of the axle housing.

9. An axle assembly with an integrated suspension mount comprising:
an axle housing having a first leg extending toward a first wheel and a second leg extending toward a second wheel;
a first suspension bracket assembly substantially surrounding a portion of said first leg to attach said axle housing to a suspension main support member;
a second suspension bracket assembly substantially surrounding a portion of said second leg to attach said axle housing to the suspension main support member; and
wherein each of said first and second bracket assemblies includes a first bracket member and a second bracket member held fixed relative to each other wherein a preload is exerted against said first and second bracket members as said first and second bracket members are attached to each other at an installed attachment interface, said preload force controlling a suspension load path by exerting a positive contact force only along predefined contact areas on said axle housing.

10. The axle assembly of claim 9 wherein said axle housing includes a polygonal cross-section including a plurality of angled surfaces and wherein said predefined contact areas are said angled surfaces.

11. The axle assembly of claim 10 wherein said angled surfaces define four corner portions of said axle housing that extend transversely relative to an upper horizontal housing wall portion, a lower horizontal housing wall portion, and vertical housing wall portions.

12. The axle assembly of claim 11 wherein said first bracket and second bracket members comprise an upper bracket and a lower bracket with one of said upper or lower brackets extending along an upper surface of said axle housing and contacting two upper corners of said four corner portions and with the other of said upper or lower brackets extending along a bottom surface and a pair of vertical side walls of said axle housing and contacting two lower corners of said four corner portions wherein said installed attachment interface comprises a welded joint.

13. The axle assembly of claim 11 wherein said first bracket member comprises a fore bracket extending partially along an upper surface of said axle housing, a first vertical side surface of said axle housing, and partially along a lower surface of said axle housing, said fore bracket contacting one upper corner and one lower corner of said four corner portions and wherein said second bracket member comprises an aft bracket extending partially along said upper surface of said axle housing, a second vertical side surface of said axle housing opposite from said first vertical side surface, and partially along said lower surface of said axle housing, said aft bracket contacting one upper corner and one lower corner of said four corner portions and wherein said installed attachment interface comprises a bolted joint.

14. A method of attaching a suspension bracket assembly to an axle comprising the steps of:
(a) holding a first suspension bracket member relative to a second suspension bracket member to form a suspension bracket assembly;
(b) positioning the suspension bracket assembly over one end of an axle housing;
(c) attaching the first and second suspension bracket members together; and
(d) applying a preload force against the suspension bracket assembly during step (c).

15. The method of claim 14 wherein step (c) further includes welding the first and second suspension bracket members together.

16. The method of claim 14 wherein step (c) further includes bolting the first and second suspension bracket members together.

17-19. (canceled)

20. The suspension bracket assembly of claim 1 wherein said first attachment interface comprises a weld interface and said second attachment interface comprises a bolted joint.

21. The suspension bracket assembly of claim 1 wherein said first and second bracket members are held fixed relative to each other prior to attachment to the axle housing.

22. The method of claim 14 wherein step (a) is performed after step (b) and step (c) is performed after step (b).

23. The method of claim 14 wherein step (a) includes holding the first and second suspension bracket members fixed relative to each other and step (d) includes exerting the preload force through the suspension bracket assembly and against the axle housing along predefined contact areas.
